(19) United States
(12) Patent Application Publication
(10) Pub. No.: US 2005/0016962 A1
(43) Pub. Date: Jan. 27, 2005

(54) Switch mechanism

(76) Inventors: Friedrich Loebner, Berlin (DE); Gunnar Lutzke, Berlin (DE)

Correspondence Address: MORRISON & FOERSTER LLP, 1650 TYSONS BOULEVARD, SUITE 300, MCLEAN, VA, 22102, US

(21) Appl. No.: 10/182,394

(22) PCT Filed: Oct. 4, 2001
(86) PCT No.: PCT/DE01/03877

(30) Foreign Application Priority Data
Nov. 30, 2000 (DE) 10061164.8

(51) Int. Cl. H01H 9/30

(52) U.S. Cl. 218/84

(57) ABSTRACT

The aim of the invention is to be able to arrange a switch mechanism comprising a hydraulic damping element (7) in two different assembly positions on a switch. To this end, the hydraulic damping element (7) must demonstrate a full functional capacity in both assembly positions. In order to ensure the same functional capacity in a first, for example, vertical assembly position and in a second, for example, horizontal assembly position, the damping element (7) is arranged in a position which deviates by 45° from the vertical.

### CLAIM FOR PRIORITY

This is a national stage of PCT/DE01/03877 filed 4 Oct. 2001 which is based on German application 10061164.8 filed 30 Nov. 2000.

### TECHNICAL FIELD OF THE INVENTION

The invention relates to a switch mechanism with a pivotably mounted, gravity-opposing hydraulic damping element for damping a switching movement.

### BACKGROUND OF THE INVENTION

A switch mechanism of this type is known for example from the brochure “SF₆ circuit breaker HPL” of the Asea company, June 1986. In it, a switch mechanism is schematically represented on page B05-A:23. The switch mechanism represented is a stored-energy spring mechanism. The necessary operating energy is provided by the relaxation of previously stressed spring assemblies. The operating energy is transmitted via a gear mechanism, which has gear wheels, shafts and levers.

To damp the high forces abruptly occurring in a switching operation, damping elements which absorb excess energy when an end position of the gear mechanism is reached are provided. In the case of the switch mechanism represented, two damping elements are provided. One damping element is provided for the switching-on movement and one damping element is provided for the switching-off movement. The damping element for the switching-on movement is designed as a hydraulic damping element and has a cylinder in which a piston moves within a hydraulic fluid. Hydraulic damping elements of this type have a gas volume above the hydraulic fluid. It must be ensured that the piston is always completely bathed in the hydraulic fluid, in order always to ensure a consistent damping characteristic.

Switches of different structural designs require attachment of the respective switch mechanisms at different positions in different assembly positions. On account of the alignment of the damping elements, it is not readily possible for the switch mechanism to be assembled on the switch in different positions. To ensure that the piston of the damping element in the cylinder is always completely surrounded by the hydraulic fluid, different switch mechanisms must be designed for a vertical assembly position and a horizontal assembly position.

### SUMMARY OF THE INVENTION

The present invention discloses designing a switch mechanism such that a consistent functional capability of the hydraulic damping element is ensured in different assembly positions.

In one embodiment of the invention, a switch mechanism includes the damping element being arranged in a position in which it is deflected by 45° from the vertical and is able to swing slightly about this angular position.

In the embodiment of such an arrangement of the damping element, it is ensured that the piston is immersed in the hydraulic fluid and consequently preserves its damping characteristic. Independently of a vertical or horizontal assembly position of the switch mechanism on the switch, the position of the damping element is maintained. Consequently, the switch mechanism can be used universally. The slight swinging about the angular position of 45° makes it possible for movements which proceed on a circular path to be effectively damped. Such an arrangement allows a low-cost, reliable hydraulic damping element to be used in the switch mechanism.

### BRIEF DESCRIPTION OF THE DRAWINGS

The invention is shown in the drawings and described in more detail below on the basis of the exemplary embodiments. In the drawings:

FIG. 1 shows the schematic construction of a switch mechanism in a first assembly position.

FIG. 2 shows the schematic construction of the switch mechanism in a second assembly position.

### DETAILED DESCRIPTION OF THE INVENTION

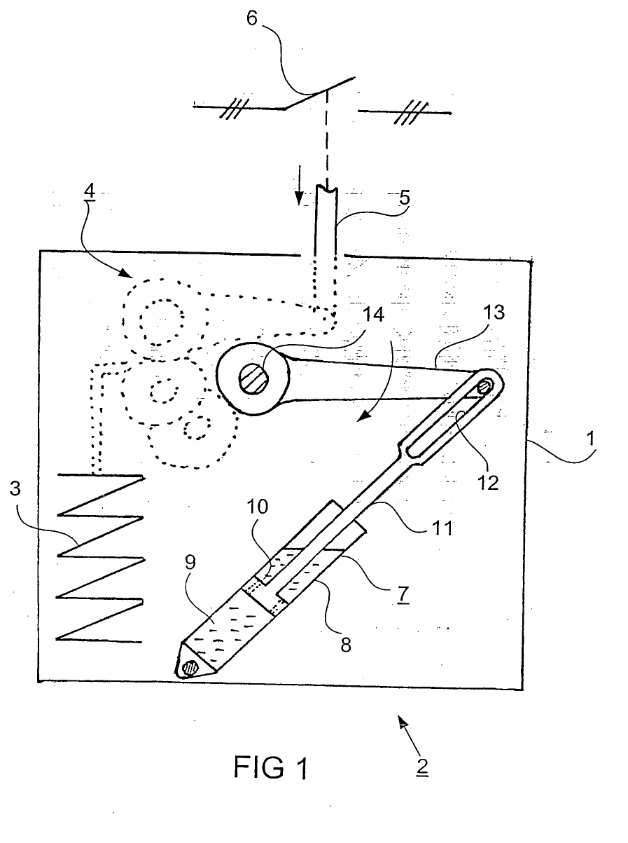

FIG. 1 shows a housing 1 of a stored-energy spring mechanism 2. The stored-energy spring mechanism 2 has a spring 3 for providing the operating energy. The spring 3 can be stressed by an electric motor (not represented). The spring 3 acts on a gear mechanism 4, which is indicated in the FIG. 1 by dashed lines. The gear mechanism 4 transmits the energy provided by the spring 3 to a drive rod 5, which drives the switching poles 6 of an electrical switching device. A damping element 7 is provided for damping the abruptly occurring switching movements. The damping element 7 is swung out from the vertical by an angle of about 45° and has a cylinder 8 which is filled with hydraulic fluid 9 and in which a piston 10 moves. The damping element 7 is arranged pivotably on the housing 1. The piston 10 is designed such that, in the event of great relative speeds of the piston 10 and cylinder 8, it moves with high resistance within the hydraulic fluid 9. To accomplish this movement characteristic, the piston 10 has overflow channels. The piston 10 is fastened to a piston rod 11 and is guided by the latter. The piston rod 11 has an elongate hole 12, by means of which it is in operative connection with a pivotable lever 13. The pivotable lever 13 is arranged on a shaft 14 of the gear mechanism 4. The lever 13 transmits the rotational movement of the shaft 14, which is moved when there is a switching-on operation. In this case, the rotational movement of the shaft 14 and the movement of the drive rod 5 are coordinated such that, shortly before reaching the end position, the damping effect of the damping element 7 commences and the switching-on movement is damped. Depending on the design of the mechanism, it may be possible that damping is required for the switching-on movement and for the switching-off movement. In this case, a separate damping element is to be provided for each of the movements, both being deflected in a similar way from the vertical, in order to ensure universal use of the switch mechanism both in a horizontal position and in a vertical position.

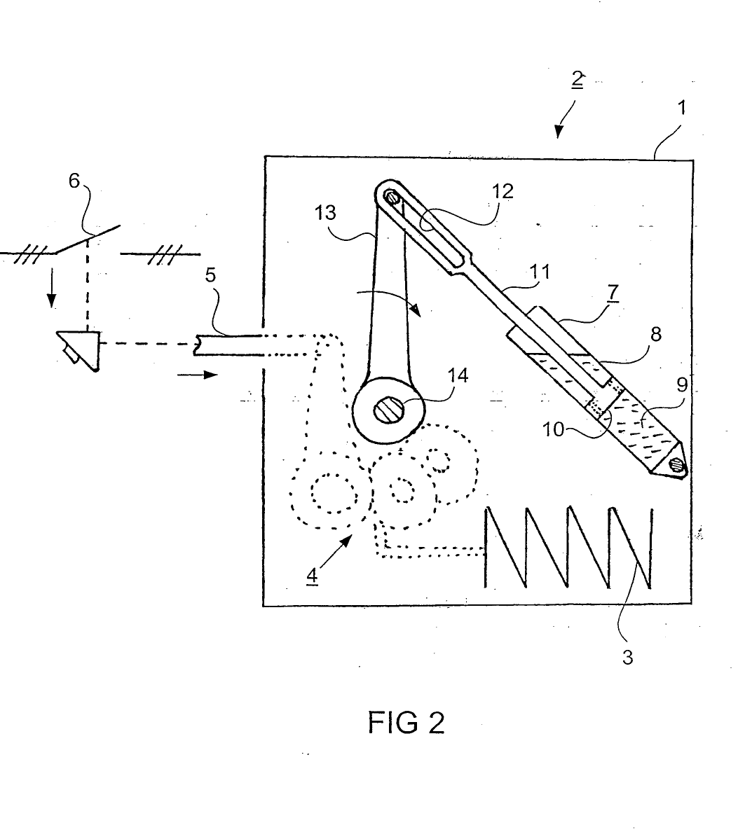

In order to transfer the switch mechanism from the vertical assembly position into the horizontal assembly position (vertical and horizontal assembly positions relate to the position of the drive rod 5), it is preferable to pivot the switch mechanism through 90° about a pivot axis lying parallel to the shaft 14. The horizontal assembly position is represented in FIG. 2. In this assembly position, the damping element 7 has a deflection of about 45° from the vertical. Consequently, full functional capability of the damping element 7 is ensured in two assembly positions that are perpendicular to each other.

1. A switch mechanism having a pivotably mounted, gravity-opposing hydraulic damping element for damping a switching movement, wherein the damping element is arranged in a position such that it is deflected by about 45° from the vertical and is configured to swing slightly about the angular position.
